(19) United States
(12) Patent Application Publication
(10) Pub. No.: US 2007/0227618 A1
(43) Pub. Date: Oct. 4, 2007

(54) Method and an Apparatus for Applying and Evenly Distributing a Quantity of Particulate Material

(75) Inventor: Carsten D. Simonsen, Odense (DK)

Correspondence Address: KLEIN, O'NEILL & SINGH, LLP, 43 CORPORATE PARK, SUITE 204, IRVINE, CA, 92606, US

(73) Assignee: Cabinplant International A/S, Harby (DK)

(21) Appl. No.: 10/574,094

(22) PCT Filed: Sep. 29, 2004
(86) PCT No.: PCT/DK04/00660

§ 371 Date: Feb. 22, 2007

(30) Foreign Application Priority Data
Sep. 29, 2003 (DK) PA 2003 01415

(51) Int. Cl. B65G 69/04; B65B 1/20

(52) U.S. Cl. 141/78

(57) ABSTRACT

A method of applying and evenly distributing a quantity of particulate material such as ground or dried coffee within a shallow tray (22), comprises the steps of providing the quantity, delivering the quantity within the tray, the tray having a plurality of pins (40) to be positioned within the particulate material while vibrating the tray, vibrating the tray horizontally at a low vibrational frequency and for a specific period of time for causing the particulate material to be evenly distributed within the tray, transferring the quantity from the tray to a further processing station such as a freezing station or a drying station. The quantity is provided from an overhead distributor such as an overhead openable hopper. The pins (40) may be stationary or movable relative to the vibrating tray (22).

The present invention relates to a method of applying and evenly distributing a quantity of a particulate material within a shallow tray. The present invention further relates to an apparatus for the application and distribution of the quantity of the particulate material within the shallow tray.

Within the technical field of producing frozen and dried products such as frozen or dried fruit or vegetables or ground or dried and frozen coffee, a problem exists in obtaining an even distribution of the particulate material within the shallow tray in which the material is handled and transferred to a freezing station. It is to be understood that it is of the outmost importance for obtainment of a homogenous frozen product that the material being a particulate material is evenly distributed within the shallow tray from which the particulate material is transferred to the freezing station. Provided the particulate material is unevenly distributed within the tray constituting a transfer tray, part of the material may not be dried when exposed to a low freezing temperature due to an accumulation of particulate material and therefore, in order to minimize the process time, the particulate material should be transferred as a homogenous layer from the shallow transfer tray to the processing station being a freezing or drying station.

It is to be understood that the technique of obtaining an even distribution of material within a shallow tray constituting a transfer container may be used within numerous technical fields within the foodstuff processing industry, examples being the field of producing dried and frozen coffee, the field of producing dried fruit or vegetables conventionally used for breakfast meals, etc.

The technique of using vibrational motion for moving particulate material or for distributing particulate material is well known within the art and is described in numerous publications such as DE 19 39 718, U.S. Pat. No. 3,712,347, DE 36 03 275, U.S. Pat. No. 5,983,519, U.S. Pat. No. 3,146,997, U.S. Pat. No. 3,968,818, EP 0 119 104, FR 2 739 844, GB 296 742, GB 102 677 and U.S. Pat. No. 3,216,344. Reference is made to the above-mentioned patents and patent applications and the above US patents are further hereby incorporated in the present specification by reference.

It is an object of the present invention to provide a simple and reliable technique for the application and distribution of the particulate material within a shallow tray in which the material is received which technique ensures an even distribution of the particulate material within the tray.

It is a further feature of the present invention that the technique of applying and evenly distributing the particulate material within the tray provides a delicate and minimum force impact to the particulate material.

The above object and the above feature together with numerous other objects, features and advantages which will be evident from the below detailed description of the presently preferred embodiments of the technique according to the present invention are in accordance with the teachings of the present invention obtained by a method of applying and evenly distributing a quantity of particulate material such as ground or dried coffee within a shallow tray, comprising:
providing the quantity,
delivering the quantity within the tray, the tray having a plurality of pins to be positioned within the particulate material while vibrating the tray,
vibrating the tray horizontally at a low vibrational frequency and for a specific period of time for causing the particulate material to be evenly distributed within the tray, and
transferring the quantity from the tray to a further processing station such as a freezing station or a drying station.

According to the teachings of the present invention, the even distribution of the particulate material within the shallow tray in which the material is received, is simply obtained by the combination of a plurality of pins extending into the particulate material received within the tray and the horizontal vibration of the tray at a low frequency such as a frequency of 0.5-25 Hz such as 1-20 Hz, e.g. 2-15 Hz such as 3-10 Hz, preferably approximately 5-6 Hz, such as 0.5-2 Hz, 2-4 Hz, 4-6 Hz, 6-8 Hz, 8-10 Hz, 10-12 Hz, 12-14 Hz, 14-16 Hz, 16-18 Hz, 18-20 Hz, 20-22 Hz, 22-25 Hz and for a specific fairly short period of time such as a period of time less than 15 sec. or 15 sec.-2 min. such as 1-3 sec., 3-5 sec., 5-7 sec., 7-9 sec., 9-11 sec., 11-13 sec., 13-15 sec., preferably approximately 9 Hz or 15-30 sec. 30-60 sec., 60-120 sec. The vibration of the tray is to be performed in a horizontal direction exclusively without causing the material to be shaken vertically in order to prevent the material from being deteriorated and also for the obtainment of an efficient rearranging or repositioning of the particulate material within the tray.

According to a particular feature of the method according to the present invention, the rearranging or repositioning of the particulate material within the tray for the obtainment of an even distribution of the material within the tray is improved by the provision of a plurality of stationary or movable pins which are positioned within the particulate material while vibrating the tray,

The quantity of the particulate material to be evenly distributed in accordance with the teachings of the present invention may be provided in any adequate manner by means of any mechanical means such as a conveyer belt or in accordance with the presently preferred embodiment of the method according to the present invention be provided from an overhead distributor such as an overhead openable hopper for ensuring that the quantity is readily introduced into the specific area defined within the vibrational tray.

The vibrational tray may in accordance with the teachings of the present invention have a bottom surface constituted by any solid or pliable means such as a moveable plate or alternatively and preferably a flexible and foldable foil or web commonly known within the technical field as a shuttle conveyer belt. Through the utilization of a shuttle conveyer belt constituting the vibrational surface, a simple and reliable and further wear-resistant means is provided for the transfer of the particulate material to the further processing station.

The pins improving the even distribution of material within the tray and also decreasing the time necessary for the obtainment of the even distribution of the material within the tray may according to two alternative embodiments of the method according to the present invention be constituted by movable pins extending into the tray from the frame in which the tray is suspended for allowing the horizontal vibration, or alternatively be constituted by stationary pins, i.e. pins moving along with the tray. In this context, the term movable is defined relative to the horizontally vibrating or moving tray as the tray constitutes the reference point for the motion between the pins and the tray provided that the pins and the tray are moving relative to one another.

Surprisingly, it has been realised that the stationary pins cause the particulate material to be swiftly repositioned provided the pins are positioned spaced apart in the direction of the horizontal vibrational motion of an order of several times such as one order of magnitude (order of 10) the amplitude of the vibrational motion. Provided more pins be positioned, the repositioning of the particulate material is on the one hand accomplished more rapidly and on the other hand provided the pins are positioned spaced apart, the process of rearranging and repositioning the particulate material for obtaining the even distribution of the material within the tray is prolonged. The pins are, for allowing the pins to be used in combination with the above described shuttle conveyer belt preferably provided as pins extending from an overhead bar into the shallow tray and as stated above the pins are preferably stationary relative to the tray. Alternatively, pins may be moved relative to the tray as the pins may be stationary relative to the frame in which the vibrational tray is suspended for the vibrational motion.

The present invention further relates to as stated above an apparatus for applying and evenly distributing a quantity of a particulate material within a shallow tray. The above object, the above features together with numerous other objects, features and advantages which will be evident from the below detailed description of the presently preferred embodiments of the technique according to the present invention are in accordance with the teachings of the present invention obtained by an apparatus for applying and evenly distributing a quantity of particulate material such as ground or dried coffee within a shallow tray, comprising:
a delivery means for delivering the quantity,
the shallow tray constituted by a vibrational tray for vibrating at a low frequency and being positioned below the delivery means for receiving the quantity from the delivery means and having a plurality of pins to be positioned within the quantity while vibrating the tray.
a vibrational generating means connected to the tray for vibrating the vibrational tray for causing the quantity received within the tray to be evenly distributed within the tray,
a timer for actuating the vibrational generating means for a specific period of time for causing the vibrational tray to be vibrated for a specific period of time set by the timer, and
a transfer means for transferring a quantity from the tray to a further processing station such as a freezing station or a drying station.

The apparatus according to the present invention may further advantageously be implemented in accordance with above described advantageous and preferred embodiments of the method according to the present invention. Still further, the vibrational tray of the apparatus according to the present invention may preferably be vibrated horizontally at a frequency of frequency of 0.5-25 Hz such as 1-20 Hz, e.g. 2-15 Hz, such as 3-10 Hz further preferably approximately 5 Hz.

In the presently preferred embodiment of the apparatus according to the present invention, the amplitude (RMS: Root Mean Square) of the vibration of the vibrational surface is of the order of 5-50 mm, such as 8-25 mm, preferably approximately 20 mm, the vibrational impact being of a sinusoidal configuration or alternatively any other configuration.

The present invention is now to be further described with reference to the drawings in which

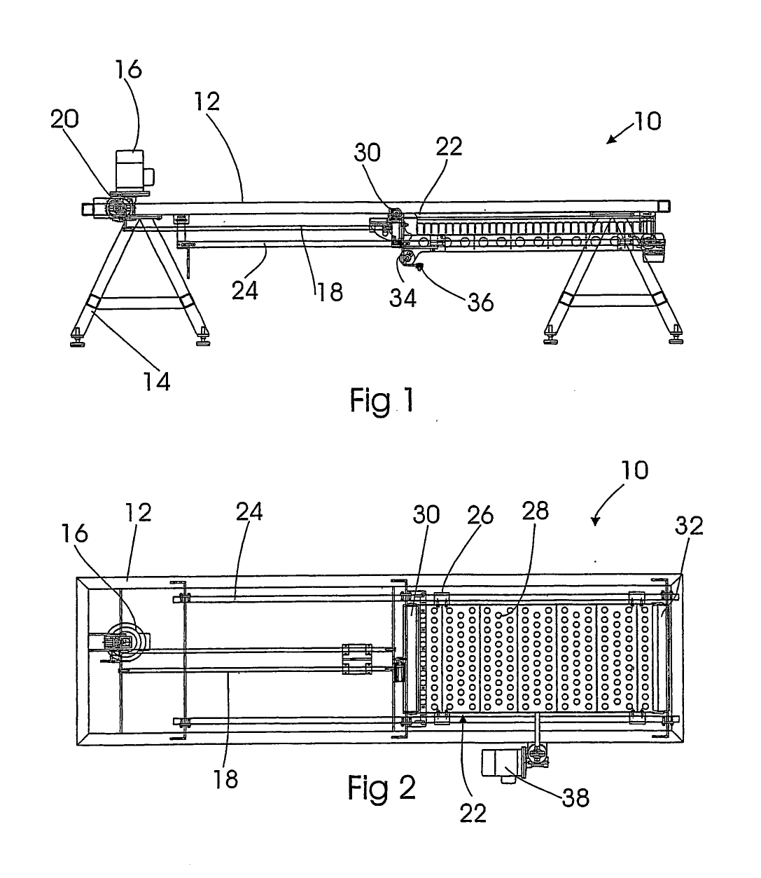

FIG. 1 is a vertical elevational view of a first and presently preferred embodiment of an apparatus according to the present invention for the handling of granulate material, in particular granulate coffee for providing an even distribution of the granulate coffee within a shallow tray of the apparatus,

FIG. 2 is a top view of the apparatus shown in FIG. 1 illustrating the tray of the apparatus,

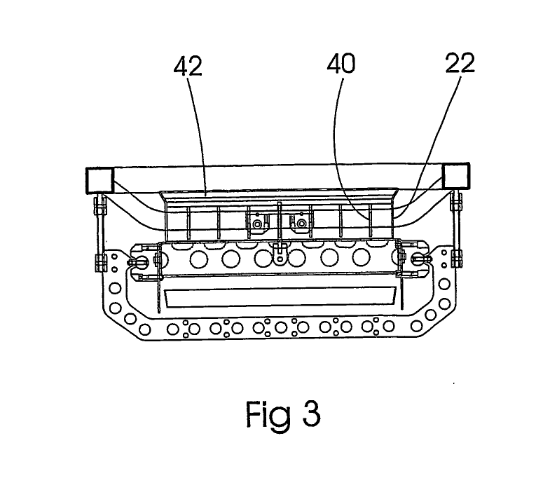

FIG. 3 is a vertical sectional view of the apparatus shown in FIGS. 1 and 2,

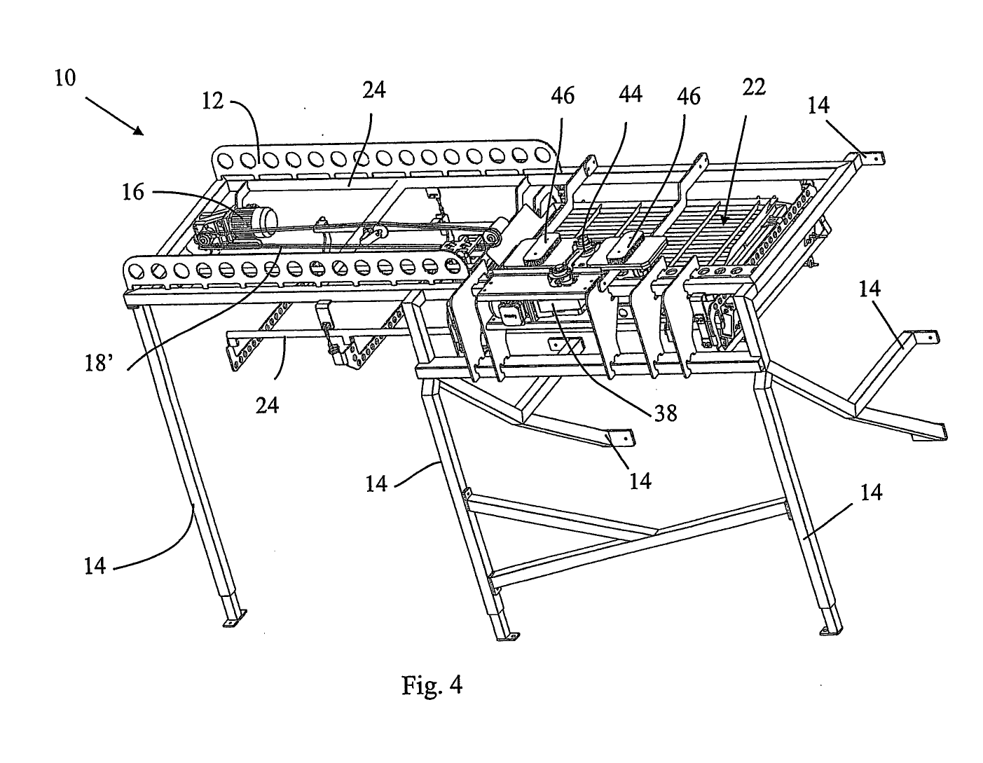

FIG. 4 is a perspective and schematic view of a second embodiment of the apparatus according to the present invention,

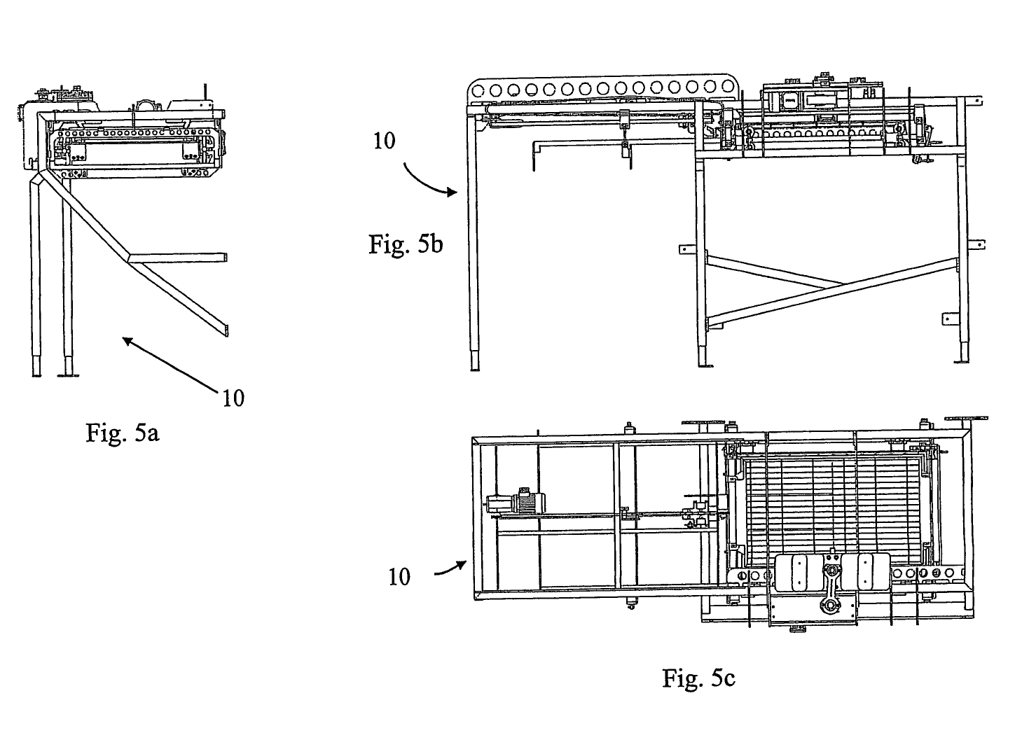

FIGS. 5a, 5b and 5c are an elevational end view, an elevational side view and a top view, respectively, of the second embodiment of the apparatus according to the present invention shown in FIG. 4, and

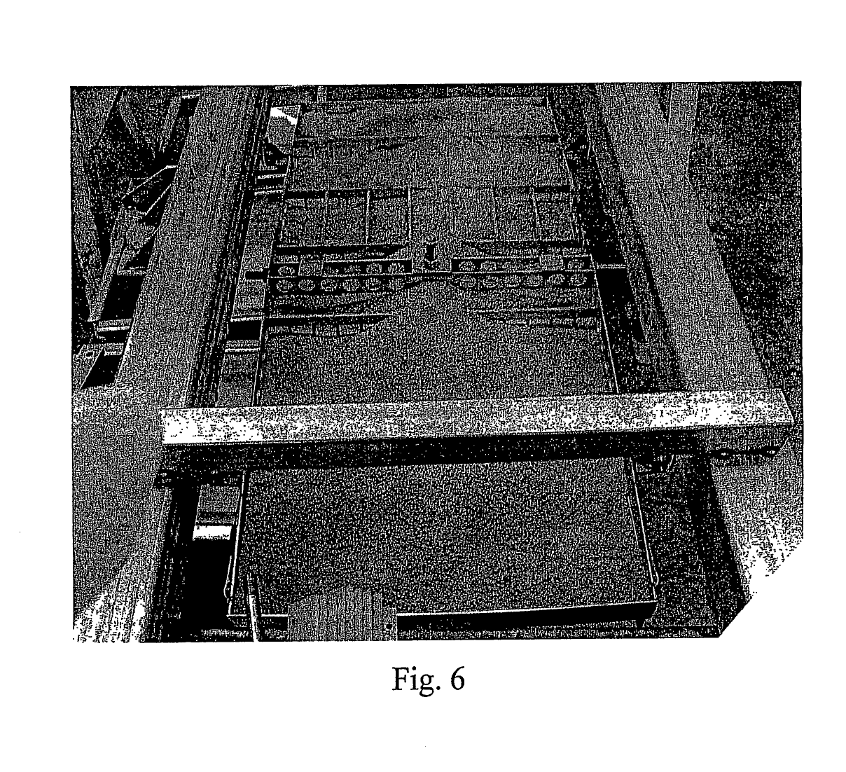

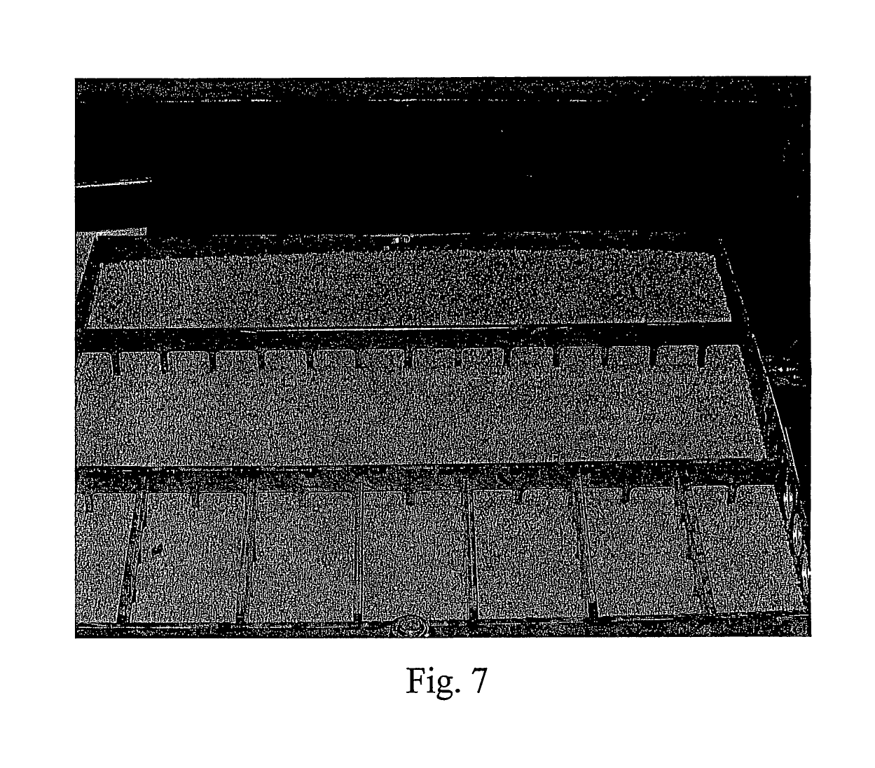

FIGS. 6 and 7 are photographs of a prototype apparatus illustrating the introducing granulate coffee into the tray of the apparatus and the effect of the provision of certain pins within the tray for the promotion of the even distribution of the material within the tray, respectively.

In the below description, a technique of evenly distributing a particulate material such as granulate coffee or similar product is described. In this context, the term particulate material or granulate material is to be construed a general term comprising any foodstuff product having a size varying within the interval 0.1-10 mm equivalent to the major dimension of e.g. a sphere. The material in question may e.g. be dried or ground coffee or fruit components such as slices of bananas, hazelnuts and similar nuts, abricots, apples or any other product which is dried by freezing at a low temperature such as the temperature of −50° C., preferably by sublimation.

The technique in particular relates to the step of evenly distributing the material in question such as the granulate coffee before transferring the material into a freezing tray which necessitates an even distribution of the material for ensuring an even drying of the material.

In FIG. 1, a first and presently preferred embodiment of the apparatus for the even distribution of granulate coffee is shown designated the reference numeral 10 in its entirety. The apparatus 10 is also shown in FIGS. 2 and 3. The apparatus 10 comprises a top frame 12 which is supported on a total of eight supports, four of which are shown in FIG. 1 and designated the reference numeral 14. At a left-hand end of the frame 12, a motor 16 is mounted, which motor is connected to a drive rod 18 through a gear assembly 20. The drive rod 18 is connected to a tray 22 which is journalled on supporting rails 24 for allowing the tray to be moved from the right-hand position shown in FIGS. 1 and 2 to a left-hand position juxtaposed the left-hand end of the frame 12 and in close proximity to the motor 16 during which motion the particulate material received within the tray 22 is expelled into a freezing tray not shown in the drawings.

The tray 22 is as mentioned above supported on the rails 24 and is suspended relative to the rails 24 and the frame 12 for allowing the tray to be vibrated at a low frequency such as a frequency of 5 Hz. The suspension elements are shown in FIG. 2 one of which being designated the reference numeral 26. The suspension elements 26 are made from low-temperature resistant polymer material such as nylon, web or similar flexible and bendable material which may stand exposure to an extremely low temperature such as −50° C. The tray 22 includes a perforated bottom 28 and vertical side walls defining a shallow tray in which the granulate coffee material is introduced. On top of the perforated bottom 28, a web of a shuttle conveyer belt is mounted, which shuttle conveyer belt is fixated relative to the tray at the left end thereof by means of a beam 30 and passed round a right-hand roller 32 and further round a left-hand roller 34 and fixated relative to the tray by means of a clamp assembly 36. The shuttle conveyer belt serves the purpose of delivering the granulate coffee to the freezing tray position below the rails 24 at the left-hand end of the apparatus 10.

The tray 22 is as mentioned above constituted by a vibrational tray which is caused to vibrate horizontally exclusively by means of a vibrational generating motor assembly 38 connected to a bottom bolt assembly of the tray for causing the tray to oscillate horizontally at the frequency generated by the oscillation generating assembly 38 such as a frequency of 5 Hz and at an amplitude of 20 mm RMS.

A particular feature of the apparatus relates to the provision of overhead mounted pins which extend into the interior space defined within the tray. In FIG. 3, these pins are shown, one of which is designated the reference numeral 40 and which pins are supported on a transversal beam 42. The pins 40 extend down into the inner space defined within the tray 22 to positions closely above the shuttle conveyer belt and serve the purpose of promoting the rearranging or redistribution of the granulate material being granulate coffee received within the tray for promoting the even distribution of the granulate coffee through the horizontal vibration or oscillation. The feature relating to the provision of the vertical pins 42 which are moved along with the tray 22 is demonstrated in the photographs shown in FIGS. 6 and 7.

In FIGS. 4, 5a, 5b and 5c, a second embodiment of the apparatus according to the present invention is shown. In FIGS. 4, 5a, 5b and 5c, components or elements identical to components or elements, respectively, described above with reference to FIGS. 1-3 and serving the same purpose as the components or elements, respectively, described above, are designated the same reference numerals as used in FIGS. 1-3 whereas components or elements serving the same purpose as components or elements, respectively, described above with reference to FIGS. 1-3, however, differing from the corresponding component or element, respectively, shown in FIGS. 1-3, is designated the same integer, however added a marking for representing the difference.

Basically, the apparatus shown in FIGS. 4, 5a, 5b and 5c differs from the above described first embodiment shown in FIGS. 1-3 in that the motion of the tray 22 from the filling position in the left hand part of FIG. 4 to and from the vibration position in the right hand part of FIG. 4 is generated by means of a motor and a belt drive designated the reference numerals 16 and 18′, respectively. Furthermore, the frame 14 shown in FIGS. 4, 5a, 5b and 5c are intended to be bolted to a supporting floor and further to a vertical wall at which the apparatus is intended to be positioned. Still further, the apparatus shown in FIG. 1 differs from the above described first embodiment shown in FIGS. 1-3 in that a set of counterweights 46 are provided which are caused to move in a counteracting vibration relative to the vibrating tray driven by a connecting rod 44 which is connected to an output shaft of the motor 38. The counterbalancing counterweights 44 serve to minimise the mechanical impact to the supporting frame and further to the floor and wall to which the apparatus is fixated during the process of vibrating the material received within the tray 22 and in generating the counterbalancing action, the mechanical impact is basically eliminated.

In FIGS. 6 and 7, a prototype apparatus is shown, which apparatus includes a tray similar to the tray 22 shown in FIGS. 1-3. Centrally within the tray shown in FIG. 6, a bolt is shown protruding upwardly which bolt was in the test run of the prototype apparatus connected to a drive rod of the oscillation generating motor similar to the assembly 38 shown in FIG. 2.

In FIG. 6, the granulate coffee is simply introduced into the tray from above and positioned defining a hill at the center of the tray. It is, however, to be realized that in the specific application, the granulate coffee or any other material may be introduced and positioned off center within the tray or at the one end or both ends or further alternatively at one side or both sides of the tray for promoting the rearranging of the granulate material. After a short period of time of horizontally oscillating the tray from left to right in FIG. 6, the granulate material is rearranged and repositioned and as shown in FIG. 7, the pins extending into the granulate material promotes the rearranging or repositioning of the granulate material.

In FIG. 7, different sections of the uppermost end of the tray shown in FIG. 6 is illustrated after the short term oscillation of the tray and as is shown at the bottom end of FIG. 7, the part of the tray including the pins extending into the granulate material, the granulate material is perfectly repositioned defining a level or horizontal top surface. At the uppermost end of the tray shown in FIG. 7, the granulate material has to some extent shifted its position as compared to the position of the granulate material shown in FIG. 6 however, as is evident from the photograph of FIG. 6, the granulate material still defines a larger thickness at the center of the tray as compared to the outermost sides of the tray. Comparing the area not including the pins with the area including the pins, it is obvious that the horizontal oscillation or vibration of the granulate material causing the rearrangement of the granulate material is enhanced through the provision of the pins.

The prototype apparatus shown in FIGS. 1-3 was made from stainless steel including a tray measuring 1220 mm×520 mm. The tray was capable of evenly distributing a quantity of six kg granulate coffee within a period of time of 30 sec. which oscillated at a frequency of 5 Hz and being exposed to a vibrational amplitude of 20 mm RMS.

The apparatus shown in FIGS. 4, 5a, 5b and 5c was like the prototype apparatus described above made from stainless steel including a tray measuring 1200 mm×700 mm. The tray was driven by the motor also driving the counterbalancing weights shown in FIGS. 4, 5a, b and 5c at a frequency of 6 Hz for a period of 9 sec. causing a quantity of 10 kg granulate coffee to be evenly distributed by exposure to a vibrational amplitude of 20 mm RMS.

1. A method of applying and evenly distributing a quantity of particulate material such as ground or dried coffee within a shallow tray, comprising:
providing said quantity,
delivering said quantity within said tray, said tray having a plurality of pins to be positioned within said particulate material while vibrating said tray,
vibrating said tray horizontally at a low vibrational frequency and for a specific period of time for causing said particulate material to be evenly distributed within said tray, and
transferring said quantity from said tray to a further processing station.

2. The method according to claim 1, said quantity being provided from an overhead distributor.

3. The method according to claim 1, wherein said tray has a bottom surface selected from the group consisting of a flexible and foldable foil, a flexible and foldable web, and a shuttle conveyer belt.

4. The method according to claim 1, said plurality of pins constituting movable pins extending into said tray from a stationary frame in which said tray is suspended for allowing said horizontal vibration.

5. The method according to claim 1, said plurality of pins being constituted by stationary pins fixed to said tray and movable with said tray.

6. The method according to claim 1, said vibrational tray being vibrated horizontally at a frequency of 0.5-25 Hz.

7. The method according to claim 1, said vibrational tray being vibrated for a period of time of 15 sec.-2 min.

8. An apparatus for applying and evenly distributing a quantity of particulate material such as ground or dried coffee within a shallow tray, comprising:
a delivery means for delivering said quantity,
said shallow tray constituted by a vibrational tray for vibrating at a low frequency and being positioned below said delivery means for receiving said quantity from said delivery means and having a plurality of pins to be positioned within said quantity while vibrating said tray,
a vibrational generating means connected to said tray for vibrating said vibrational tray for causing said quantity received within said tray to be evenly distributed within said tray,
a timer for actuating said vibrational generating means for a specific period of time for causing said vibrational tray to be vibrated for a specific period of time set by said timer, and
a transfer means for transferring a quantity from said tray to a further processing station.

9. The apparatus according to claim 8, said delivery means being constituted by an overhead distributor positioned above said tray.

10. The apparatus according to claim 8, said tray having a bottom surface selected from the group consisting of a flexible and foldable foil, a flexible and foldable web constituted by a shuttle conveyer belt.

11. The apparatus according to claim 8, said plurality of pins constituting movable pins extending into said tray from a stationary frame in which said tray is suspended for allowing said horizontal vibration.

12. The apparatus according to claim 8, said plurality of pins being constituted by stationary pins fixed to said tray and movable with said tray.

13. The apparatus according to claim 8, the vibrational tray being vibrated horizontally at a frequency of 0.5-25 Hz.
